(19) United States
(12) Patent Application Publication
(10) Pub. No.: US 2025/0142505 A1
(43) Pub. Date: May 1, 2025

(54) Method and Apparatus for SSB Measurement Time Configuration in Communication Network

(71) Applicant: Telefonaktiebolaget LM Ericsson (publ), Stockholm (SE)

(72) Inventors: Ming Li, Stockholm (SE); Zhixun Tang, Beijing (CN)

(21) Appl. No.: 18/837,923

(22) PCT Filed: Feb. 9, 2023
(86) PCT No.: PCT/EP2023/053245

§ 371 Date: Aug. 13, 2024

(30) Foreign Application Priority Data
Feb. 14, 2022 (WO) PCT/CN2022/076233

(51) Int. Cl. H04W 56/00

(52) U.S. Cl. CPC H04W 56/0045

(57) ABSTRACT

Embodiments of the present disclosure provide methods and apparatuses for enhancing SMTC in communication network. A method (100) performed by a network node may comprise: determining (S102) a first configuration for a synchronization signal block, SSB, measurement time; determining (S104) a second configuration for indicating an offset related to the SSB measurement time; and transmitting (S106) the first configuration and the second configuration to a wireless device, for indicating that the wireless device performs a SSB measurement, based at least on the first configuration and/or the second configuration. SSB refers to a combination of synchronization signal and physical broadcast channel. A method (200) performed by a wireless device may comprise: receiving (S202), a first configuration and a second configuration from a network node in a communication network; and performing (S204) a SSB measurement, based at least on the first configuration and/or the second configuration. The first configuration is for a SSB measurement time, and the second configuration is for indicating an offset related to the SSB measurement time. According to embodiments of the present disclosure, an offset related to the SSB measurement time may be indicated.

### TECHNICAL FIELD

The present disclosure relates generally to the technology of wireless communication, and in particular, to a method and an apparatus for enhancing SSB measurement time configuration (SMTC) in communication network. SSB may refer to a Synchronization Signal Block, which may be particularly a combination of synchronization signal (SS) and physical broadcast channel (PBCH) in the communication network in exemplary scenarios.

### BACKGROUND

With the development of requirements for communication services, it is necessary to complement mobile communication networks on the ground by many other kinds of technologies. For example, to some underserved areas where a fix base station is hard to deploy, a movable base station/relay will be an advantageous choice. One example for such movable base station/relay is a satellite communication network.

As an example, there is an ongoing resurgence of satellite communications. Several plans for satellite networks have been announced in the past few years. Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work.

In 3GPP Release 15, the first release of the 5G system (5GS) was specified. This is a new generation's radio access technology intended to serve use cases such as enhanced mobile broadband (eMBB), ultra-reliable and low latency communication (URLLC), and mMTC. 5G includes the New Radio (NR) access stratum interface and the 5G Core Network (5GC). The NR physical and higher layers are reusing parts of the LTE specification, and to that add needed components when motivated by new use cases. One such component is the introduction of a sophisticated framework for beam forming and beam management to extend the support of the 3GPP technologies to a frequency range going beyond 6 GHz.

In Release 15, 3GPP started the work to prepare NR for operation in a Non-Terrestrial Network (NTN). The work was performed within the study item “NR to support Non-Terrestrial Networks” and resulted in TR 38.811 [1]. In Release 16, the work to prepare NR for operation in an NTN network continued with the study item “Solutions for NR to support Non-Terrestrial Network” [2].

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A moving base station/relay in the network may cause some issues, such as moving cells or switching cells, or propagation delay, etc. Such delay will also influence SSB transmitted to the terminal device served by the network. When a terminal device tries to measure a SSB in a predetermined measurement time window/gap, some part of the SSB might be missed due to a time offset of the SSB caused by the propagation delay, etc. A measurement result obtained by the terminal device will be interfered.

Certain aspects of the present disclosure and their embodiments may provide solutions to these or other challenges. Specific method and apparatus for enhancing SMTC in a communication network are provided.

A first aspect of the present disclosure provides a method performed by a network node in a communication network. The method may comprise: determining a first configuration for a SSB measurement time; determining a second configuration for indicating an offset related to the SSB measurement time; and transmitting the first configuration and the second configuration to a wireless device, for indicating that the wireless device performs a SSB measurement, based at least on the first configuration and/or the second configuration. SSB refers to a combination of synchronization signal and physical broadcast channel.

In embodiments of the present disclosure, the first configuration may comprise: a periodicity, and a duration of the SSB measurement time. Further, the second configuration may comprise: a timing offset window related to the duration of the SSB measurement time.

In embodiments of the present disclosure, the duration of the SSB measurement time may be extended by the timing offset window, to start earlier compared to the first configuration; and/or the duration of the SSB measurement time may be extended by the timing offset window, to end later compared to the first configuration.

In embodiments of the present disclosure, the duration of the SSB measurement time may be shifted by the timing offset window, to start earlier compared to the first configuration; or the duration of the SSB measurement time may be shifted by the timing offset window, to end later compared to the first configuration.

In embodiments of the present disclosure, the timing offset window may be constant; or the timing offset window may be periodically changeable with an update rate.

In embodiments of the present disclosure, the second configuration may be enabled or disabled, based at least on an indication from the network node, and/or a report from the wireless device, and/or a predefined rule.

In embodiments of the present disclosure, the second configuration may be determined, based at least on the first configuration.

In embodiments of the present disclosure, the second configuration may be determined, based at least on a measurement to a SSB and/or a cell by the wireless device, and/or by a network node serving the wireless device.

In embodiments of the present disclosure, the second configuration may be determined, based at least on a location of the wireless device.

In embodiments of the present disclosure, the second configuration may comprise a plurality of timing offset windows selectable by the wireless device for the SSB measurement time.

In embodiments of the present disclosure, the first configuration may comprise at least a first SSB measurement time and a second SSB measurement time; and the second configuration may comprise at least a first timing offset window for a first duration of the first SSB measurement time, and a second timing offset window for a second duration of the second SSB measurement time.

In embodiments of the present disclosure, the first timing offset window and/or the second timing offset window may be disabled, when the first duration is close to or collides with the second duration.

In embodiments of the present disclosure, whether the first timing offset window or the second timing offset window is disabled may be determined based on a priority of the first timing offset window and/or a priority of the second timing offset window.

In embodiments of the present disclosure, the first configuration and the second configuration may be provided from a satellite to the wireless device; and the second configuration may be determined, based at least on a location of the wireless device, an ephemeris data and/or feeder link delay of the satellite.

In embodiments of the present disclosure, the second configuration may be enabled or disabled for the wireless device, based on a change of at least one of follows: a validity or invalidity of the ephemeris data, a validity or invalidity of the location of the wireless device, a type of the satellite, a location of at least one neighbor satellite, or a time to be covered by at least one neighbor satellite. Alternatively, the second configuration may be enabled or disabled for the wireless device, based on at least one of follows: a capacity of the wireless device; or the first configuration.

In embodiments of the present disclosure, a measurement procedure and requirements for measuring SSB during the SSB measurement time may be based on the first configuration and/or the second configuration.

In embodiments of the present disclosure, the requirements for measuring SSB may comprise at least on of following: a measurement time, a measurement accuracy, a number of identified cells to measure per carrier, and/or a number of beams to measure.

In embodiments of the present disclosure, a scheduling restriction may be applied to the SSB measurement time, based on the first configuration and/or the second configuration.

In embodiments of the present disclosure, a duration of the SSB measurement time and/or the second configuration may be disabled, when the duration is close to or collides with a paging occasion.

In embodiments of the present disclosure, the first configuration and the second configuration may be transmitted via broadcasting to a plurality of wireless devices including the wireless device. Alternatively, the first configuration and the second configuration may be transmitted via dedicated message to the wireless devices.

In embodiments of the present disclosure, the network node may comprise a satellite or a base station relayed by the satellite.

In embodiments of the present disclosure, the wireless device may be in an idle mode, or an inactivated mode, or a connected mode.

A second aspect of the present disclosure provides a method performed by a terminal device in a communication network. The method may comprise: receiving, a first configuration and a second configuration from a network node in a communication network; and performing a SSB measurement, based at least on the first configuration and/or the second configuration. The first configuration is for a SSB measurement time, and the second configuration is for indicating an offset related to the SSB measurement time.

In embodiments of the present disclosure, the first configuration may comprise: a periodicity, and a duration of the SSB measurement time. Further, the second configuration may comprise: a timing offset window related to the duration of the SSB measurement time.

In embodiments of the present disclosure, the duration of the SSB measurement time may be extended by the timing offset window, to start earlier compared to the first configuration; and/or the duration of the SSB measurement time may be extended by the timing offset window, to end later compared to the first configuration.

In embodiments of the present disclosure, the duration of the SSB measurement time may be shifted by the timing offset window, to start earlier compared to the first configuration; or the duration of the SSB measurement time may be shifted by the timing offset window, to end later compared to the first configuration.

In embodiments of the present disclosure, the timing offset window may be constant; or the timing offset window may be periodically changeable with an update rate.

In embodiments of the present disclosure, the second configuration may be enabled or disabled, based at least on an indication from the network node, and/or a report from the wireless device, and/or a predefined rule.

In embodiments of the present disclosure, the second configuration may be determined, based at least on the first configuration.

In embodiments of the present disclosure, the second configuration may be determined, based at least on a measurement to a SSB and/or a cell by the wireless device, and/or by a network node serving the wireless device.

In embodiments of the present disclosure, the second configuration may be determined, based at least on a location of the wireless device.

In embodiments of the present disclosure, the second configuration may comprise a plurality of timing offset windows selectable by the wireless device for the SSB measurement time.

In embodiments of the present disclosure, the first configuration may comprise at least a first SSB measurement time and a second SSB measurement time; and the second configuration may comprise at least a first timing offset window for a first duration of the first SSB measurement time, and a second timing offset window for a second duration of the second SSB measurement time.

In embodiments of the present disclosure, the first timing offset window and/or the second timing offset window may be disabled, when the first duration is close to or collides with the second duration.

In embodiments of the present disclosure, whether the first timing offset window or the second timing offset window is disabled may be determined based on a priority of the first timing offset window and/or a priority of the second timing offset window.

In embodiments of the present disclosure, the first configuration and the second configuration may be provided from a satellite to the wireless device; and the second configuration may be determined, based at least on a location of the wireless device, an ephemeris data and/or feeder link delay of the satellite.

In embodiments of the present disclosure, the second configuration may be enabled or disabled for the wireless device, based on a change of at least one of follows: a validity or invalidity of the ephemeris data, a validity or invalidity of the location of the wireless device, a type of the satellite, a location of at least one neighbor satellite, or a time to be covered by at least one neighbor satellite. Alternatively, the second configuration may be enabled or disabled for the wireless device, based on at least one of follows: a capacity of the wireless device; or the first configuration.

In embodiments of the present disclosure, a measurement procedure and requirements for measuring SSB during the SSB measurement time may be based on the first configuration and/or the second configuration.

In embodiments of the present disclosure, the requirements for measuring SSB may comprise at least on of following: a measurement time, a measurement accuracy, a number of identified cells to measure per carrier, and/or a number of beams to measure.

In embodiments of the present disclosure, a scheduling restriction may be applied to the SSB measurement time, based on the first configuration and/or the second configuration.

In embodiments of the present disclosure, a duration of the SSB measurement time and/or the second configuration may be disabled, when the duration is close to or collides with a paging occasion.

In embodiments of the present disclosure, the first configuration and the second configuration may be transmitted via broadcasting to a plurality of wireless devices including the wireless device. Alternatively, the first configuration and the second configuration may be transmitted via dedicated message to the wireless devices.

In embodiments of the present disclosure, the network node may comprise a satellite or a base station relayed by the satellite.

In embodiments of the present disclosure, the wireless device may be in an idle mode, or an inactivated mode, or a connected mode.

A third aspect of the present disclosure provides an apparatus for a network node in a communication network. The apparatus may comprise: a processor; and a memory, the memory containing instructions executable by the processor. The apparatus for the network node is operative for: determining a first configuration for a SSB measurement time; determining a second configuration for indicating an offset related to the SSB measurement time; and transmitting the first configuration and the second configuration to a wireless device, for indicating that the wireless device performs a SSB measurement, based at least on the first configuration and/or the second configuration. The SSB refers to a combination of synchronization signal and physical broadcast channel.

In embodiments of the present disclosure, the apparatus may be further operative to perform the method according to any of above embodiments.

A fourth aspect of the present disclosure provides an apparatus for a wireless device. The apparatus for the wireless device may comprise: a processor; and a memory, the memory containing instructions executable by the processor. The apparatus for the wireless device is operative for: receiving, a first configuration and a second configuration from a network node in a communication network; and performing a SSB measurement, based at least on the first configuration and/or the second configuration. The first configuration is for a SSB measurement time, and the second configuration is for indicating an offset related to the SSB measurement time.

In embodiments of the present disclosure, the apparatus may be further operative to perform the method according to any of above embodiments.

A fifth aspect of the present disclosure provides computer-readable storage medium storing instructions, which when executed by at least one processor, cause the at least one processor to perform the method according to any of above embodiments.

Embodiments herein afford many advantages. According to embodiments of the present disclosure, a manner for enhancing SMTC in communication network may be provided.

Particularly, an offset related to the SSB measurement time may be indicated. The specific SSB measurement may be adjusted accordingly. Therefore, the influence of a moving base station/relay, such as a moving satellite, for the time align of SSB may be reduced. The measurement quality for the SSB in such situations may be enhanced.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is a diagram showing an example architecture of a satellite network with bent pipe transponders.

FIG. 1B is a diagram showing an exemplary illustration of SSB, SMTC window, and measurement gap.

FIG. 2 is a flow chart showing a method performed by a network node, according to embodiments of the present disclosure.

FIG. 3 is a flow chart showing a method performed by wireless device, according to embodiments of the present disclosure.

FIG. 4 is a diagram showing an example of the signaling flow between network node and UE.

FIG. 5A is a diagram showing multiple SMTC signaled by the network node to the wireless device.

FIG. 5B is a diagram showing a 4 ms SMTC window.

FIG. 5C is a diagram showing offsets of SMTC configurations.

FIG. 5D is a diagram depicting an example of SMTC timing offset windows (STOWs) at both sides of SMTC duration.

FIG. 5E is a diagram depicting an example of STOWs at one side of SMTC duration.

FIG. 5F is a diagram showing time shifted STOW.

FIG. 5G is a diagram showing a solution with STOW concept to problem in FIG. 5C.

FIG. 5H is a diagram showing exemplary parameters in the STOW configuration.

FIG. 5I is a diagram showing exemplary multiple STOWs for multiple SMTC.

FIG. 6 is a diagram showing switching between different scenarios.

FIG. 7A is a block diagram showing an exemplary apparatus for a network node, which is suitable for perform the method according to embodiments of the disclosure.

FIG. 7B is a block diagram showing an exemplary apparatus for a wireless device, which is suitable for perform the method according to embodiments of the disclosure.

FIG. 8 is a block diagram showing an apparatus/computer readable storage medium, according to embodiments of the present disclosure.

FIG. 9A is a schematic showing units for the exemplary apparatus for a network node, according to embodiments of the present disclosure.

FIG. 9B is a block diagram showing an exemplary apparatus for a second network node, which is suitable for perform the method according to embodiments of the disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

FIG. 15 shows a communication diagram of a host 1502 communicating via a network node 1504 with a UE 1506 over a partially wireless connection in accordance with some embodiments.

### DETAILED DESCRIPTION

Interest to adapt NB-IoT and LTE-M for operation in NTN is growing. As a consequence, 3GPP Release 17 contains both a work item on NR NTN [3] and a study item on NB-IoT and LTE-M support for NTN [4].

A satellite radio access network usually includes the following components: a satellite that refers to a space-borne platform; an earth-based gateway that connects the satellite to a base station or a core network, depending on the choice of architecture; feeder link that refers to the link between a gateway and a satellite; access link, or service link, that refers to the link between a satellite and a UE.

Depending on the orbit altitude, a satellite may be categorized as low earth orbit (LEO), medium earth orbit (MEO), or geostationary earth orbit (GEO) satellite: LEO: typical heights ranging from 250-1,500 km, with orbital periods ranging from 90-120 minutes; MEO: typical heights ranging from 5,000-25,000 km, with orbital periods ranging from 3-15 hours; GEO: height at about 35,786 km, with an orbital period of 24 hours.

Two basic architectures can be distinguished for satellite communication networks, depending on the functionality of the satellites in the system.

To an architecture of transparent payload (also referred to as bent pipe architecture), the satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE.

To an architecture of regenerative payload, the satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP release 17, only the transparent payload architecture is considered.

A satellite network or satellite based mobile network may also be called as non-terrestrial network (NTN). On the other hand, mobile network with base stations on the group may also be called as terrestrial network (TN) or non-NTN network. A satellite within NTN may be called as NTN node, NTN satellite or simply a satellite.

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable wireless communication standards. For example, the wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device” refers to any end device that can access a communication network and receive services therefrom, and “wireless (terminal) device” may refer to any end device that can access a communication network and receive services therefrom wirelessly. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “wireless device”, “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

The following can be considered as main challenges that need to be addressed in NTN: moving satellites (resulting in moving cells or switching cells), long propagation delays.

Moving satellites (resulting in moving or switching cells) causes new challenges since the default assumption in terrestrial network design, e.g., NR or LTE, is that cells are stationary. This is not the case in NTN, especially when LEO satellites are considered. A LEO satellite may be visible to a UE on the ground only for a few seconds or minutes. There are two different options for LEO deployment. The beam/cell coverage is fixed with respect to a geographical location with earth-fixed beams, i.e., steerable beams from satellites ensure that a certain beam covers the same geographical area even as the satellite moves in relation to the surface of the earth. On the other hand, with moving beams a LEO satellite has fixed antenna pointing direction in relation to the earth's surface, e.g., perpendicular to the earth's surface, and thus cell/beam coverage sweeps the earth as the satellite moves. In that case, the spotbeam, which is serving the UE, may switch every few seconds.

Long propagation delays cause new challenges since the propagation delays in terrestrial mobile systems are usually less than 1 millisecond. In contrast, the propagation delays in NTN can be much longer, ranging from several milliseconds (LEO) to hundreds of milliseconds (GEO) depending on the altitudes of the spaceborne or airborne platforms deployed in the NTN.

In terrestrial networks (TNs) the relative location in time of an SSB between a serving cell and a neighbor cell is fixed. The propagation delay within each cell depends on the cell size and UE location, and from UE's perspective it will only vary due to UE movement.

On the contrary, in low-earth orbit (LEO) scenarios, even the propagation delay between UE and serving cell will vary over time, due to the movement of the satellite. Furthermore, the propagation delays towards neighbor cells on neighboring satellites will also change over time. The scenario will become worse when also accounting for feeder link delay and will increase with increasing satellite altitude.

Serving cell and target cell might not be necessarily time- and frame-synchronized when belonging to different satellites. The resulting time offset in SSB transmission between different cells needs to be considered as well for SMTC window and gap configuration towards the UE.

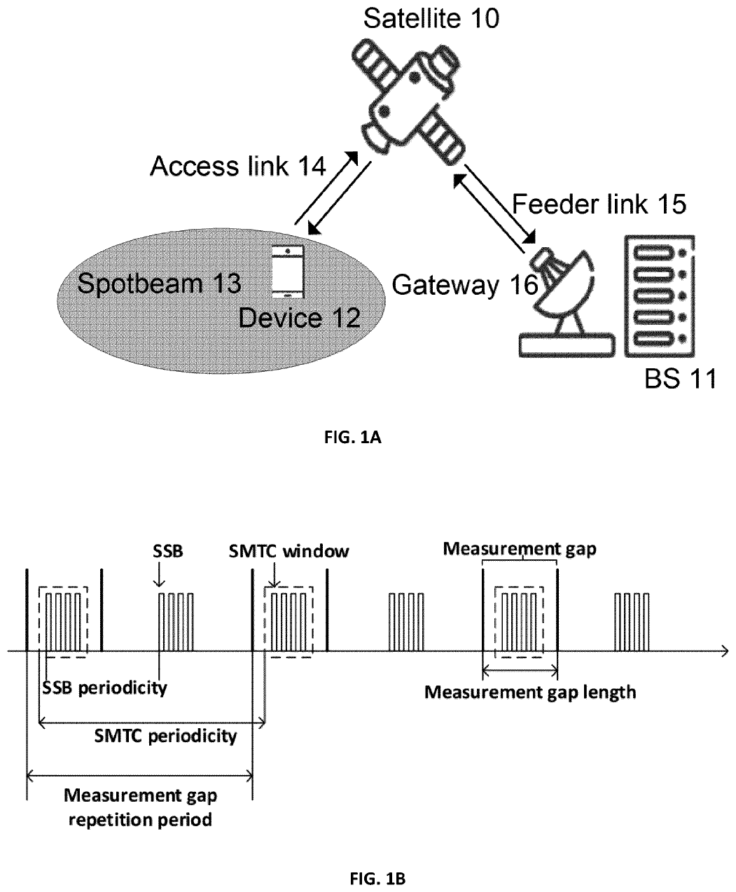

FIG. 1A shows an example architecture of a satellite network with bent pipe transponders (i.e. the transparent payload architecture). The base station (BS) 11, such as a gNB, may be integrated in the gateway 16 or connected to the gateway 16 via a terrestrial connection (wire, optic fiber, wireless link). A communication satellite 10 typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam 13. The footprint of a beam or spotbeam 13 may move over the earth's surface with the satellite movement or may be earth fixed with a beam pointing mechanism used by the satellite to compensate for the satellite's motion (where the latter may be referred to as quasi-earth-fixed beams or quasi-earth-fixed cells). The size of a spotbeam depends on the system design, which may range from tens of kilometers to a few thousands of kilometers.

In a LEO or MEO communication system, a large number of satellites deployed over a range of orbits are required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive IoT services with relaxed latency requirements, it may not even be necessary to support full earth-coverage. It may be sufficient to provide occasional or periodic coverage according to the orbital period of the constellation.

A wireless device 12 (e.g. a 3GPP UE in RRC_IDLE or RRC_INACTIVE state) is required to perform number of procedures including measurements for mobility purposes, paging monitoring, logging measurement results, tracking area update, and search for a new PLMN (public land mobile network), just to mention a few, via the access link 14. These procedures will consume power in devices, and a general trend in 3GPP has been to allow for relaxation of these procedures to prolong device battery life. This trend has been especially pronounced for IoT devices supported by reduced capability (redcap), NB-IoT and LTE-M.

Propagation delay is an important aspect of satellite communications that is different from the delay expected in a terrestrial mobile system. For a bent pipe satellite network, i.e. with an access link 14 and feeder link 15 to the gateway 16, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE (device) 12 and a satellite 10 can vary significantly, depending on the position of the satellite and thus the elevation angle ε seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | Distance | One-way | Propagation |
|---|---|---|---|---|
| Orbital | Elevation | UE <−> | propagation | delay |
| height | angle | satellite | delay | difference |
| 600 | 90° | 600 km | 2.0 ms | — |
| km | 30° | 1075 km | 3.6 ms | 1.6 ms |
| | 10° | 1932 km | 6.4 ms | 4.4 ms |
| 1200 | 90° | 1200 km | 4.0 ms | — |
| km | 30° | 1999 km | 6.7 ms | 2.7 ms |
| | 10° | 3131 km | 10.4 ms | 6.4 ms |
| 35786 | 90° | 35786 km | 119.4 ms | — |
| km | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 μs every second, depending on the orbit altitude and satellite velocity.

Such propagation delay will influence the transmission of signals between the satellite and a UE, such as a signal of SSB.

FIG. 1B is a diagram showing an exemplary illustration of SSB, SMTC window, and measurement gap.

NR synchronization signal (SS) consists of primary SS (PSS) and secondary SS (SSS). NR physical broadcast channel (PBCH) carries the very basic system information. The combination of SS and PBCH is referred to as SSB in NR. Multiple SSBs are transmitted in a localized burst set. Within an SS burst set, multiple SSBs can be transmitted in different beams. The transmission of SSBs within a localized burst set is confined to a 5 ms window. The set of possible SSB time locations within an SS burst set depends on the numerology which in most cases is uniquely identified by the frequency band. The SSB periodicity can be configured from the value set {5, 10, 20, 40, 80, 160} ms (where the unit used in the configuration is subframe, which has a duration of 1 ms).

A UE does not need to perform measurements with the same periodicity as the SSB periodicity. Accordingly, the SSB measurement time configuration (SMTC) has been introduced for NR. The signaling of SMTC window informs the UE of the timing and periodicity of SSBs that the UE can use for measurements. The SMTC window periodicity can be configured from the value set {5, 10, 20, 40, 80, 160} ms, matching the possible SSB periodicities. The SMTC window duration can be configured from the value set {1, 2, 3, 4, 5} ms (where the unit used in the configuration is subframe, which has a duration of 1 ms).

The UE may use the same RF module for measurements of neighboring cells and data transmission in the serving cell. Measurement gaps allow the UE to suspend the data transmission in the serving cell and perform the measurements of neighboring cells. The measurement gap repetition periodicity can be configured from the value set {20, 40, 80, 160} ms, the gap length can be configured from the value set {1.5, 3, 3.5, 4, 5.5, 6, 10, 20} ms. Usually, the measurement gap length is configured to be larger than the SMTC window duration to allow for RF retuning time. Measurement gap time advance is also introduced to fine tune the relative position of the measurement gap with respect to the SMTC window. The measurement gap timing advance can be configured from the value set {0, 0.25, 0.5} ms.

For Rel-17 NTN, Rel-17 NR operation may be enhanced (e.g. the SMTC configuration and UE measurement gap configuration) by addressing the issues associated with the different/larger propagation delays, and the satellites (considering e.g. their deployment, mobility, height, minimum elevation and prioritizing typical NTN scenarios).

In some examples, Rel-17 NTN does not rely only on network implementation to address the above issue.

Enhancements of the SMTC configuration may be supported for Rel-17 NTN. In some examples, new UE assistance is defined in Rel-17 NTN for network to properly (re)configure the SMTC and/or measurement gap. In some examples, for Rel-17 NTN, one or more SMTC configuration(s) associated to one frequency can be configured. For example, the SMTC configuration can be associated with a set of cells (e.g., per satellite or any other suitable set per gNB determination). For example, the multiple SMTC configurations are enabled by introducing different new offsets in addition to the legacy SMTC configuration. For example, the following improvement may be also considered:
(a) the UE may be configured with multiple SMTCs per carrier and use them all in parallel.
(b) the NW may know which SMTC (incl. offsets/periodicity, etc.) is relevant for a particular UE.
(c) there may be multiple SMTC configuration in time or for certain location only.
(d) the potential impact on the signalling may be considered, assuming this delay is a dynamic value.
(e) the feeder link delay may be also considered.

The configuration of one or multiple offsets may be based on the network implementation. It may be up to network to update the SMTC configuration of the UE to accommodate the different propagation delays. Measurement gaps enhancements may be supported.

The maximum number of SMTC in on measurement object may be 4. The multiple SMTC configurations may be enabled by introducing different new offsets in addition to the legacy SMTC configuration. The multiple SMTC configurations may be enabled by introducing different new offsets in addition to the legacy SMTC configuration. The specific maximum number of SMTC configuration in one measurement object with the same ssbFrequency can be 4. Different UE capabilities to support measurements for multiple configured SMTCs may be considered.

With regards to the maximum number of SMTCs per Frequency layer, the maximum number of SMTCs configured per measurement object for the same ssbFrequency may be 4. The number of configured parallel SMTCs to be used for requirements definition may be configured. Different UE capabilities to support measurements for multiple configured SMTCs may be needed. Capability on the number of Measurement Cell Groups may be also considered.

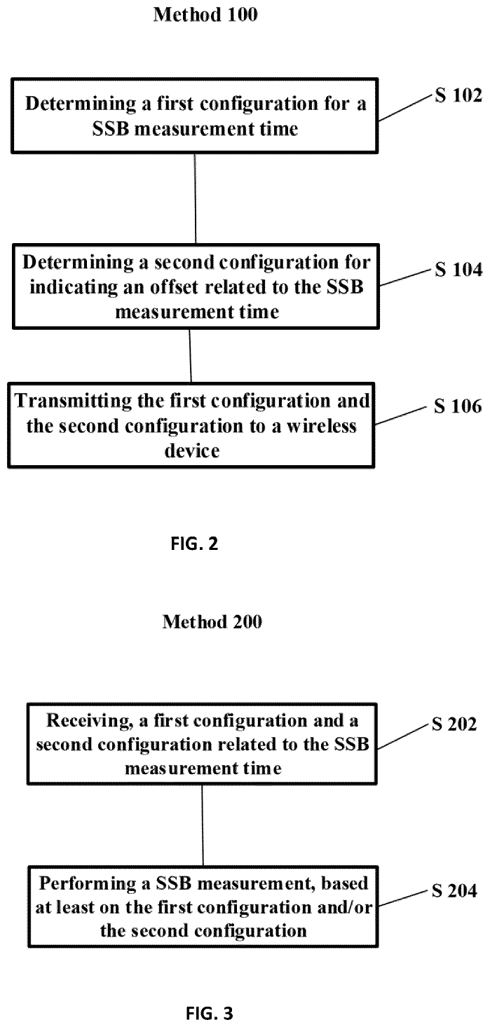

FIG. 2 is a flow chart showing a method performed by a network node, according to embodiments of the present disclosure. As shown in FIG. 2, the method 100 performed by a network node in a communication network may comprise: a step S102, determining a first configuration for a SSB measurement time; a step S104, determining a second configuration for indicating an offset related to the SSB measurement time; and a step S106, transmitting the first configuration and the second configuration to a wireless device, for indicating that the wireless device performs a SSB measurement, based at least on the first configuration and/or the second configuration. SSB refers to a combination of synchronization signal and physical broadcast channel.

According to embodiments of the present disclosure, a manner for enhancing SMTC in communication network may be provided. Particularly, an offset related to the SSB measurement time may be indicated. The specific SSB measurement may be adjusted accordingly. Therefore, the influence of a moving base station/relay, such as a moving satellite, for the time align of SSB may be reduced. The measurement quality for the SSB in such situations may be enhanced.

In embodiments of the present disclosure, the first configuration may comprise: a periodicity, and a duration of the SSB measurement time. Further, the second configuration may comprise: a timing offset window related to the duration of the SSB measurement time. For example, the timing offset window may be a SMTC timing offset window (STOW).

In embodiments of the present disclosure, the duration of the SSB measurement time may be extended by the timing offset window, to start earlier compared to the first configuration; and/or the duration of the SSB measurement time may be extended by the timing offset window, to end later compared to the first configuration.

In embodiments of the present disclosure, the duration of the SSB measurement time may be shifted by the timing offset window, to start earlier compared to the first configuration; or the duration of the SSB measurement time may be shifted by the timing offset window, to end later compared to the first configuration.

According to embodiments of the present disclosure, the SSB measurement time may be adjusted, such as extended and/or shifted, and thus the SSB signal part not covered by an original SMTC may be also measured.

In embodiments of the present disclosure, the timing offset window may be constant; or the timing offset window may be periodically changeable with an update rate.

In embodiments of the present disclosure, the second configuration may be enabled or disabled, based at least on an indication from the network node, and/or a report from the wireless device, and/or a predefined rule.

In embodiments of the present disclosure, the second configuration may be determined, based at least on the first configuration.

In embodiments of the present disclosure, the second configuration may be determined, based at least on a measurement to a SSB and/or a cell by the wireless device, and/or by a network node serving the wireless device.

In embodiments of the present disclosure, the second configuration may be determined, based at least on a location of the wireless device.

In embodiments of the present disclosure, the second configuration may comprise a plurality of timing offset windows selectable by the wireless device for the SSB measurement time.

In embodiments of the present disclosure, the first configuration may comprise at least a first SSB measurement time and a second SSB measurement time; and the second configuration may comprise at least a first timing offset window for a first duration of the first SSB measurement time, and a second timing offset window for a second duration of the second SSB measurement time.

In embodiments of the present disclosure, the first timing offset window and/or the second timing offset window may be disabled, when the first duration is close to or collides with the second duration.

In embodiments of the present disclosure, whether the first timing offset window or the second timing offset window is disabled may be determined based on a priority of the first timing offset window and/or a priority of the second timing offset window.

In embodiments of the present disclosure, the first configuration and the second configuration may be provided from a satellite to the wireless device; and the second configuration may be determined, based at least on a location of the wireless device, an ephemeris data and/or feeder link delay of the satellite.

In embodiments of the present disclosure, the second configuration may be enabled or disabled for the wireless device, based on a change of at least one of follows: a validity or invalidity of the ephemeris data, a validity or invalidity of the location of the wireless device, a type of the satellite, a location of at least one neighbor satellite, or a time to be covered by at least one neighbor satellite. Alternatively, the second configuration may be enabled or disabled for the wireless device, based on at least one of follows: a capacity of the wireless device; or the first configuration.

According to embodiments of the present disclosure, a plurality of criteria are provided for the network node or the wireless device to enable, or disable, or update the specific STOW.

In embodiments of the present disclosure, a measurement procedure and requirements for measuring SSB during the SSB measurement time may be based on the first configuration and/or the second configuration.

In embodiments of the present disclosure, the requirements for measuring SSB may comprise at least on of following: a measurement time, a measurement accuracy, a number of identified cells to measure per carrier, and/or a number of beams to measure.

According to embodiments of the present disclosure, the second configuration can be applied to a situation with multiple SMTC.

In embodiments of the present disclosure, a scheduling restriction may be applied to the SSB measurement time, based on the first configuration and/or the second configuration.

In embodiments of the present disclosure, a duration of the SSB measurement time and/or the second configuration may be disabled, when the duration is close to or collides with a paging occasion.

According to embodiments of the present disclosure, the STOW may be applied in the connected mode (with scheduling restriction) or idle mode (with paging occasion).

In embodiments of the present disclosure, the first configuration and the second configuration may be transmitted via broadcasting to a plurality of wireless devices including the wireless device. Alternatively, the first configuration and the second configuration may be transmitted via dedicated message to the wireless devices.

In embodiments of the present disclosure, the network node may comprise a satellite or a base station relayed by the satellite.

In embodiments of the present disclosure, the wireless device may be in an idle mode, or an inactivated mode, or a connected mode.

FIG. 3 is a flow chart showing a method performed by wireless device, according to embodiments of the present disclosure. As shown in FIG. 3, the method 200 performed by a wireless device may comprise: a step S202, receiving, a first configuration and a second configuration from a network node in a communication network; and a step S204, performing a SSB measurement, based at least on the first configuration and/or the second configuration. The first configuration is for a SSB measurement time, and the second configuration is for indicating an offset related to the SSB measurement time.

In embodiments of the present disclosure, the first configuration may comprise: a periodicity, and a duration of the SSB measurement time. Further, the second configuration may comprise: a timing offset window related to the duration of the SSB measurement time.

In embodiments of the present disclosure, the duration of the SSB measurement time may be extended by the timing offset window, to start earlier compared to the first configuration; and/or the duration of the SSB measurement time may be extended by the timing offset window, to end later compared to the first configuration.

In embodiments of the present disclosure, the duration of the SSB measurement time may be shifted by the timing offset window, to start earlier compared to the first configuration; or the duration of the SSB measurement time may be shifted by the timing offset window, to end later compared to the first configuration.

In embodiments of the present disclosure, the timing offset window may be constant; or the timing offset window may be periodically changeable with an update rate.

In embodiments of the present disclosure, the second configuration may be enabled or disabled, based at least on an indication from the network node, and/or a report from the wireless device, and/or a predefined rule.

In embodiments of the present disclosure, the second configuration may be determined, based at least on the first configuration.

In embodiments of the present disclosure, the second configuration may be determined, based at least on a measurement to a SSB and/or a cell by the wireless device, and/or by a network node serving the wireless device.

In embodiments of the present disclosure, the second configuration may be determined, based at least on a location of the wireless device.

In embodiments of the present disclosure, the second configuration may comprise a plurality of timing offset windows selectable by the wireless device for the SSB measurement time.

In embodiments of the present disclosure, the first configuration may comprise at least a first SSB measurement time and a second SSB measurement time; and the second configuration may comprise at least a first timing offset window for a first duration of the first SSB measurement time, and a second timing offset window for a second duration of the second SSB measurement time.

In embodiments of the present disclosure, the first timing offset window and/or the second timing offset window may be disabled, when the first duration is close to or collides with the second duration.

In embodiments of the present disclosure, whether the first timing offset window or the second timing offset window is disabled may be determined based on a priority of the first timing offset window and/or a priority of the second timing offset window.

In embodiments of the present disclosure, the first configuration and the second configuration may be provided from a satellite to the wireless device; and the second configuration may be determined, based at least on a location of the wireless device, an ephemeris data and/or feeder link delay of the satellite.

In embodiments of the present disclosure, the second configuration may be enabled or disabled for the wireless device, based on a change of at least one of follows: a validity or invalidity of the ephemeris data, a validity or invalidity of the location of the wireless device, a type of the satellite, a location of at least one neighbor satellite, or a time to be covered by at least one neighbor satellite. Alternatively, the second configuration may be enabled or disabled for the wireless device, based on at least one of follows: a capacity of the wireless device; or the first configuration.

In embodiments of the present disclosure, a measurement procedure and requirements for measuring SSB during the SSB measurement time may be based on the first configuration and/or the second configuration.

In embodiments of the present disclosure, the requirements for measuring SSB may comprise at least on of following: a measurement time, a measurement accuracy, a number of identified cells to measure per carrier, and/or a number of beams to measure.

In embodiments of the present disclosure, a scheduling restriction may be applied to the SSB measurement time, based on the first configuration and/or the second configuration.

In embodiments of the present disclosure, a duration of the SSB measurement time and/or the second configuration may be disabled, when the duration is close to or collides with a paging occasion.

In embodiments of the present disclosure, the first configuration and the second configuration may be transmitted via broadcasting to a plurality of wireless devices including the wireless device. Alternatively, the first configuration and the second configuration may be transmitted via dedicated message to the wireless devices.

In embodiments of the present disclosure, the network node may comprise a satellite or a base station relayed by the satellite.

In embodiments of the present disclosure, the wireless device may be in an idle mode, or an inactivated mode, or a connected mode.

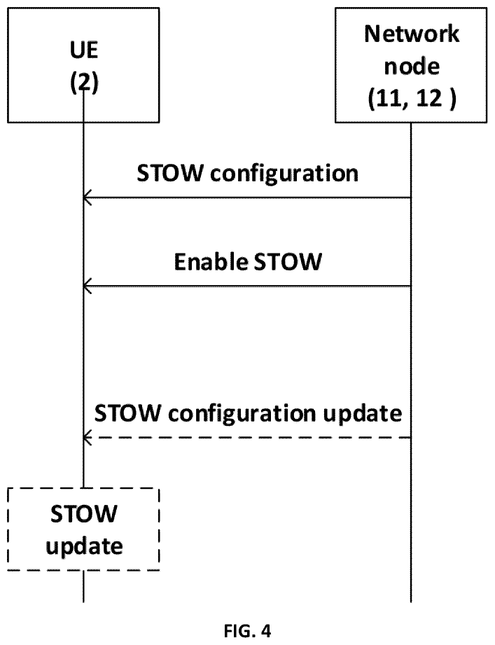

FIG. 4 is a diagram showing an example of the signaling flow between network node and UE. The network node (such as the BS 11, satellite 12) shall provide STOW configuration (the second configuration) together with existing measurement configuration (SMTC), to a UE (such as the (wireless) device 2). The STOW configuration may include exact one or more than one of the parameters {r1, tr1, s1}, or a set of parameters {r1, tr1, s1}, {r2, tr2, s2}. Further example about the specific r1, tr1, s1, etc. will be illustrated below.

Also, the network node may enable or disable utilization of STOW. It can be done via an explicit signaling, or through empty STOW configuration in RRC signaling or set STOW duration (e.g., r1)=0.

With respect to the target satellite's moving, network may update STOW configuration by sending new configuration again, or the network may have provided a plurality of sets of parameters {r1, tr1, s1}, {r2, tr2, s2} in previous STOW configuration for UE to choose a proper one to perform STOW update by the UE itself, if UE determines that there is necessity.

According to embodiments of the present disclosure, the network, e.g., a gNB, provides a UE with a SMTC, optionally associated with one or more neighbor cell(s). The configuration may include SMTC timing offset window (STOW), and optionally also includes rules for how the STOW should be defined and updated to adapt to the impact of satellite movements in a predictable manner, which allows the UE and the network, e.g., gNB, to stay synchronized in terms of the timing of the STOW with or without further signaling between the UE and the network.

According to further embodiments of the present disclosure, each UE may report the SMTC timing offset window when performing measurement. After that, the NW will provide UE with the specific SMTC and STOW per UE. Alternatively, the NW will provide UEs with a SMTC and STOW which is the union of all UEs' reporting timing offset window per cell.

According to further embodiments of the present disclosure, a window constant duration of STOW for a SMTC is associated with the SMTC duration, SMTC periodicity, and SMTC offset according to predefined rule, or configuration by network, or report by UE.

According to further embodiments of the present disclosure, a window constant duration of STOW for a SMTC is associated with Cell/SSB-IDs and/or Satellite IDs according to predefined rule or configuration by network.

According to further embodiments of the present disclosure, a window constant duration of STOW of a SMTC is periodically changeable with a constant update rate.

According to further embodiments of the present disclosure, a window variable duration of STOW of a SMTC is associated with SMTC duration, SMTC periodicity, and SMTC offset according to predefined rule or configuration by network or report by UE.

According to further embodiments of the present disclosure, a window variable duration of STOW of a SMTC is associated with Cell/SSB-IDs and/or Satellite IDs according to predefined rule or configuration by network.

According to further embodiments of the present disclosure, a window variable duration of STOW of a SMTC is periodically changeable with a constant update rate.

According to further embodiments of the present disclosure, multi-STOWs with associated variable window durations are configured with corresponding SMTC windows, if multi-SMTCs exist.

According to further embodiments of the present disclosure, a window variable duration of STOW is configured with corresponding union of SMTC windows which are overlapping, if multi-SMTCs are overlapping.

According to further embodiments of the present disclosure, scheduling restriction is applied to symbols which can be used to transmit PUCCH/PUSCH/SRS or receive PDCCH/PDSCH/TRS (Tracking Reference Signal)/CSI-RS for CQI (Channel Quality Indication), in terms of some configurations of multi-SMTC and associated STOWs.

According to further embodiments of the present disclosure, network indicates to UE the enable or disable of STOW on all SMTCs or on some of SMTCs and configured window constant duration of STOW. Those symbols which don't need to occupy STOW can be used for other purposes.

According to further embodiments of the present disclosure, UE indicates to network the enable or disable of STOW on all SMTCs or on some of SMTCs and configured window constant duration of STOW. Those symbols which don't need to occupy STOW can be used for other purposes.

The network, e.g., the gNB, should preferably base the dynamic SMTC and/or measurement gap configuration on knowledge of the UE's location and the ephemeris data and feeder link delay of the satellite serving the cell(s) the configuration targets (e.g., cell(s) associated with the configuration).

To ensure that the configuration remains valid, the network may configure the UE to report its location if it moves more than a configured maximum distance from the location where the UE received the configuration. Alternatively, or in addition, the UE may be triggered to signal its location to the network when the UE detects that the configured SMTC window and/or measurement gap no longer fully covers the SSB transmissions of the concerned neighbor cell(s), as received by the UE. These mechanisms allow the network to provide the UE with a new configuration before the UE's movements cause the concerned SSB transmissions to not be fully covered by the configured SMTC window and/or measurement gap, as seen by the UE.

Furthermore, some of the above listed embodiment examples have inherently limited validity time, because each of them contains a finite list of pre-configured updates to be applied at specific times.

Furthermore, the configurations in the other embodiment examples may also be associated with limited validity time, e.g., by including in the configuration an indication of a validity time, i.e. the time period during which the configuration is valid (or this validity time may be specified in a standard). When the configuration is no longer valid, the network should preferably provide the UE with a new one.

According to the embodiments of the present disclosure, the proposed solution provides enhancements in terms of the trade-off between flexibility and efficiency, as well as explicit details or methods for the realization of the configuration about SMTC, particularly with STOW.

Further detailed application of the embodiments of the present disclosure to a scenario including a satellite will be illustrated.

In this invention disclosure, the term “satellite” is often used even when a more appropriate term would be “gNB associated with the satellite”. The term “satellite” may also be called as a satellite node, an NTN node, node in the space etc. Here, gNB associated with a satellite might include both a regenerative satellite, where the gNB is the satellite payload, i.e. the gNB is integrated with the satellite, or a transparent satellite, where the satellite payload is a relay and gNB is on the ground (i.e. the satellite relays the communication between the gNB on the ground and the UE).

Time period or duration over which a UE can maintain connection, or can camp on, or can maintain communication, and so on to a satellite or a gNB by UE is referred to as term “coverage time” or “serving time” or “network availability” or “sojourn time” or “dwell time” etc. The term ‘Non-coverage time’, also known as “non-serving time” or “network unavailability”, or “non-sojourn time” or “non-dwell time” refers to a period of time during which a satellite or gNB cannot serve or communicate or provide coverage to a UE. Another way to interpret the availability is that is not about a satellite/network strictly not able to serve the UE due to lack of coverage but that UE does not need to measure certain “not likely to be serving cell (satellite via which serving cell is broadcasted)”. In this case, the terminology may still be as in no coverage case or it may be different, e.g. “no need to measure”.

The term node is used which can be a network node or a user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc.), O&M, OSS, SON, positioning node (e.g. E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, NR NTN, IoT NTN, LTE NTN, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmitted in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH, sPUCCH, sPUSCH, MPDCCH, NPDCCH, NPDSCH, E-PDCCH, PUSCH, PUCCH, NPUSCH etc.

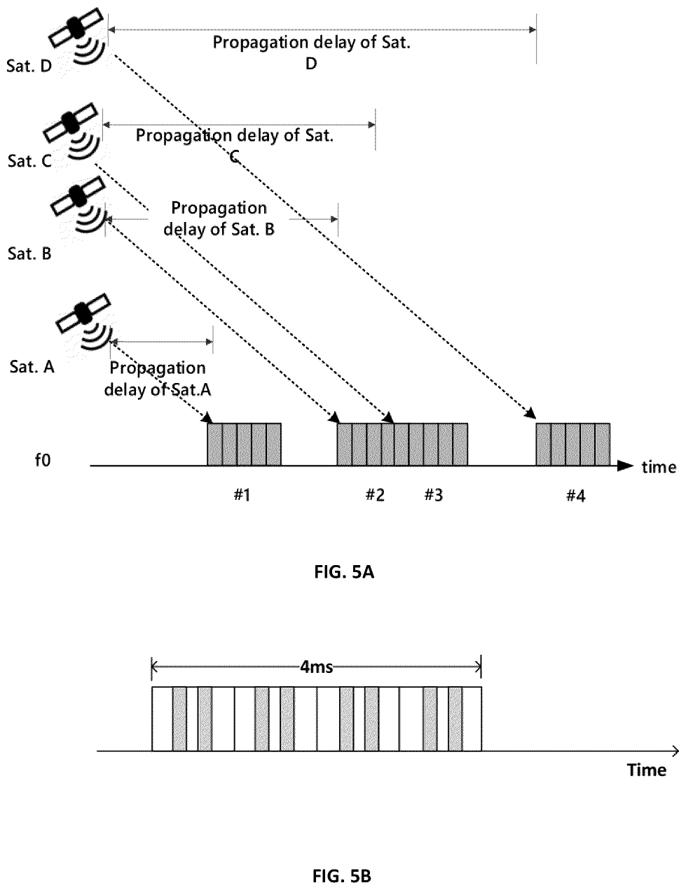

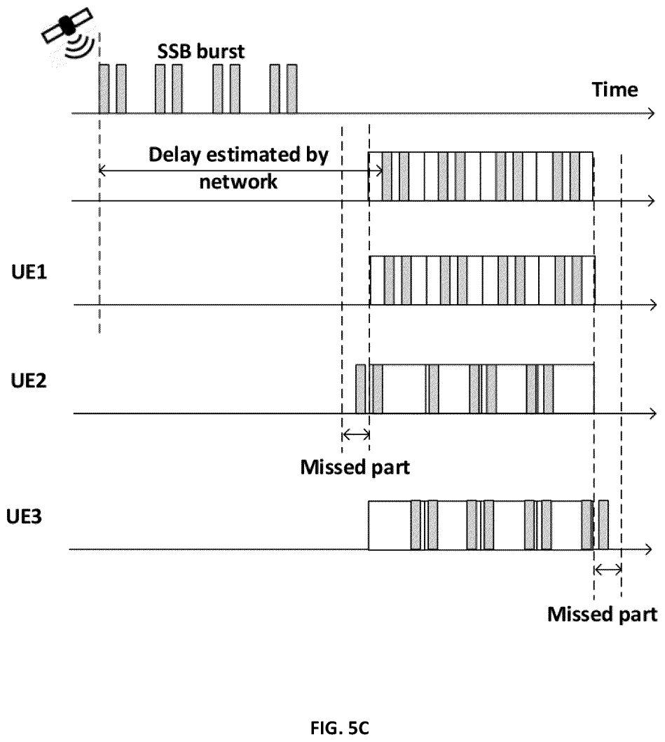

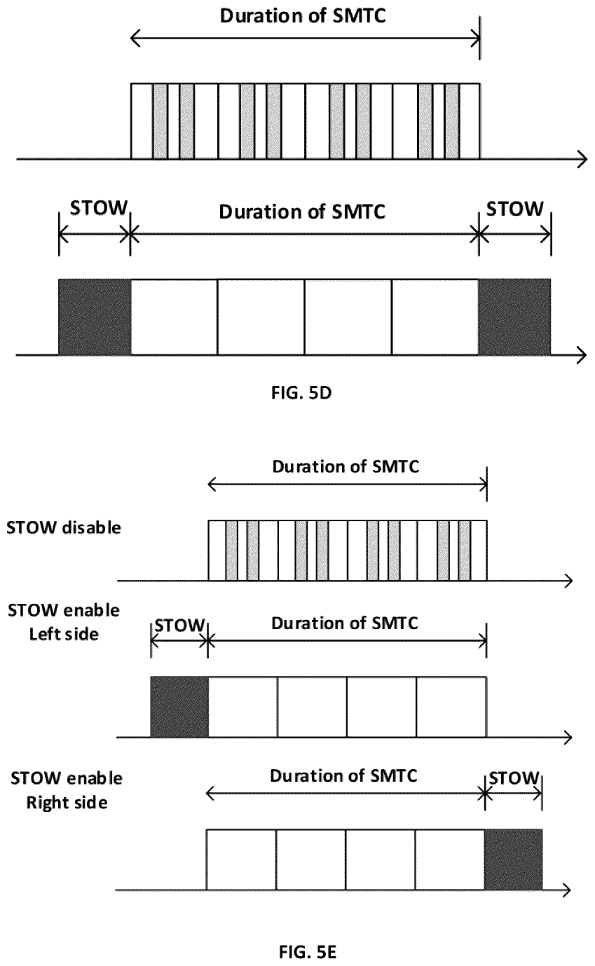

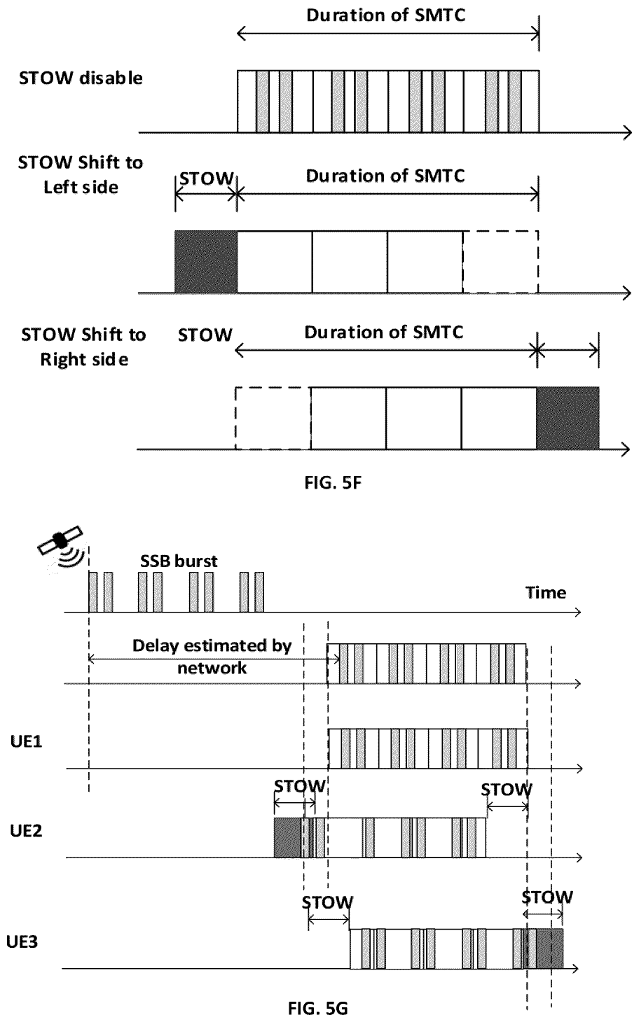

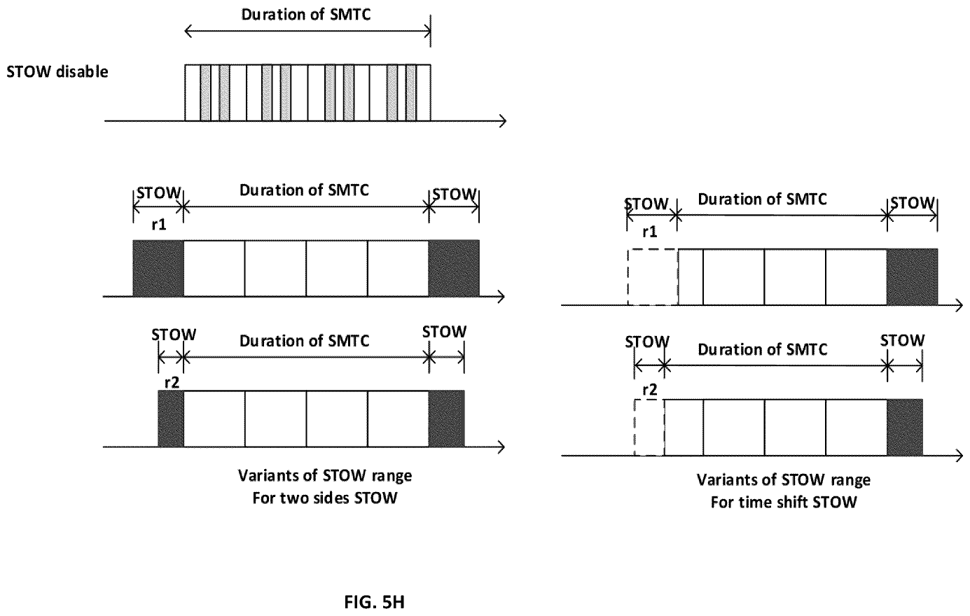

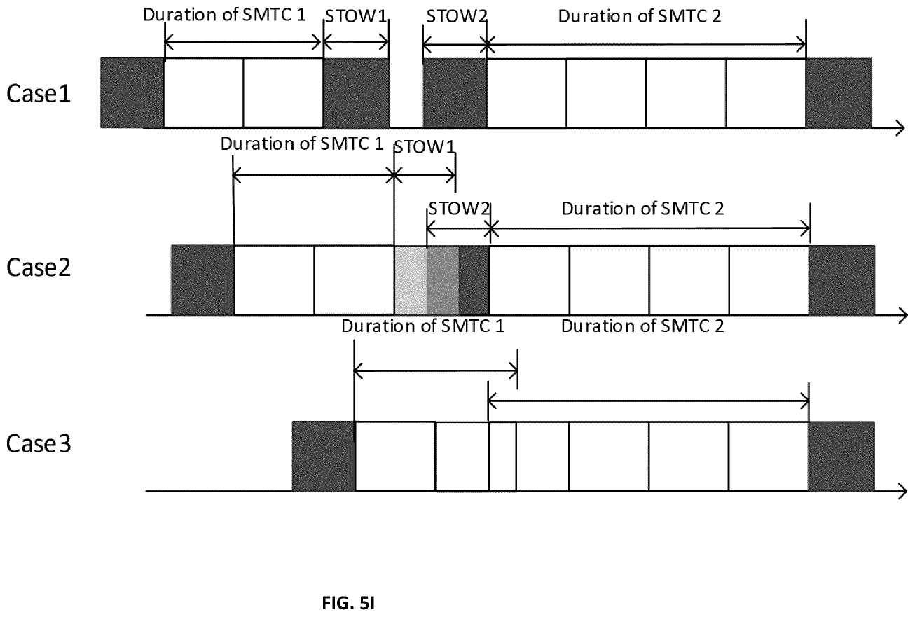

FIG. 5A is a diagram showing multiple SMTC signaled by the network node to the wireless device.

As in exemplary scenario, multiple SMTC/MG (measurement gap) configurations are enabled by introducing different new offsets. Depicted by FIG. 5A, there are 4 SMTC per MO (measurement object) or per frequency layer totally in one occasion which is broadcasted by NW, in which SMTC #1 and SMTC #4 aren't overlapped, SMTC #2 and SMTC #3 are overlapped partly due to different offsets.

SMTC #1, SMTC #2, SMTC #3 and SMTC #4 may indicate indexes of multi-SMTC configured by NW, they can also be referred to exact RRC IE parameters.

FIG. 5B is a diagram showing a 4 ms SMTC window.

The UE receives the configuration and applies the pre-configured updates according to the received configuration. Such a SMTC window configuration could be referred to as a dynamic SMTC window configuration or a dynamic SMTC.

For example, the UE may be configured with SMTC configurations that are per list of cells: This as such exists in TS 38.331 Version 17.4.0 enabling up to 4 different SMTC periodicities, and duration is kept as {sf1, sf2, sf3, sf4, sf5}.

| | |
|---|---|
| SSB-MTC3List-r16::= | SEQUENCE (SIZE(1..4)) OF SSB-MTC3-r16 |
| SSB-MTC3-r16 ::= | SEQUENCE { |
| periodicityAndOffset-r16 | CHOICE { |
| sf5-r16 | INTEGER (0..4), |
| sf10-r16 | INTEGER (0..9), |
| sf20-r16 | INTEGER (0..19), |
| sf40-r16 | INTEGER (0..39), |
| sf80-r16 | INTEGER (0..79), |
| sf160-r16 | INTEGER (0..159), |
| sf320-r16 | INTEGER (0..319), |
| sf640-r16 | INTEGER (0..639), |
| sf1280-r16 | INTEGER (0..1279) |

},

| | |
|---|---|
| duration-r16 | ENUMERATED {sf1, sf2, sf3, sf4, sf5}, |
| pci-List-r16 | SEQUENCE (SIZE (1..maxNrofPCIsPerSMTC)) OF PhysCellId |

OPTIONAL, -- Need M

| | |
|---|---|
| ssb-ToMeasure-r16 | SetupRelease { SSB-ToMeasure } |

-- Need M
}

The proposed solution may comprise that the network, e.g. a gNB, provides a UE with a SMTC, optionally associated with one or more neighbor cell(s), wherein the configuration includes SMTC timing offset window (STOW), also includes rules for how the STOW should be defined and updated to adapt to the impact of satellite movements in a predictable manner which allows the UE configures STOW accordingly. UE and network, e.g. gNB, shall stay synchronized in terms of the timing of the STOW with or without further signaling between the UE and the network.

FIG. 5C is a diagram showing offsets of SMTC configurations. The network may configure SMTC windows based on estimation of propagation delay to cell or UEs, but not all UEs can receive precisely SSB burst in SMTC windows. One example is shown in FIG. 5C, the SMTC is the same to UE1, UE2, UE3. UE1 can receive SSB in precise SMTC position, UE2's SMTC is a bit prior to actual SSB arrival time and UE3's SMTC is a bit later than actual SSB arrival time.

To mitigate the issue, SMTC timing offset window (STOW) is defined together with duration of SMTC in order to extend/shift UE practical receiving timing with less impact to scheduling. In line with existing SMTC definition, STOW provides possibility for UE of measurement outside of SMTC duration configured by network, which can be enable and disable. The enable and disable mechanism can be indicated by NW or report by UE or base on pre-defined rule. Scheduling restriction is assigned to symbols which can be used to transmit PUCCH/PUSCH/SRS or receive PDCCH/PDSCH/TRS/CSI-RS for CQI, in terms of configurations of multi-SMTC and associated STOWs. STOW may be possibly at both sides of SMTC duration.

FIG. 5D is a diagram depicting an example of STOWs at both sides of SMTC duration. If STOW is disabled, it falls back to existing SMTC. On the contrary, If STOW is enabled, UE shall measure SSB burst prior to and/or after SMTC duration with respect to UE's implementation itself, but it is vague to allow total free search without any limitation or rule if no specification of STOW. One of advantages is that network can configure STOW or set rule of configuring STOW per UE with respect to different criteria with implementation flexibility. Another advantage is network and UE have the same understanding on STOW configuration, scheduling restriction can be less compared with a fixed SMTC with longer duration.

In one specific example, the STOW can be configured with a list of time shifts as {0, 1, 2} symbols before and after the SMTC.

In another specific example, the STOW can be configured with a list of time shifts N as {0, 1, 2} μs before and after the SMTC. The scheduling restriction will be applied on the symbols as ceiling (N/NR symbol length).

In another specific example, the STOW can be configured with one or two dedicated values {N1, N2} in a list of time shifts as {−2, −1, 0, 1, 2} symbols. where, N is less than 0 if the STOW time duration is before the SMTC. N is larger than 0 if the STOW time duration is after the SMTC. NW can configure both N1 and N2 if NW wants to configure the STOW in both sides.

As one option, when applicable, the network should provide the UE with multiple dynamic SMTC and/or measurement gap configurations, wherein each SMTC and/or measurement gap configuration is associated with a group of UE or a group of cells served by the same satellite. In this case, network can configure a reference SMTC which corresponds to the shortest or longest propagation to serving cell center or cell edge, then STOW for UE can be set with one-side (left or right), which implies propagation delay to UE from satellites are longer or shorter than the said reference SMTC.

FIG. 5E is a diagram depicting an example of STOWs at one side of SMTC duration. One aspect of STOW, demonstrated in FIG. 5E, is that STOW is not always at two sides of duration of SMTC, one-side STOW also is feasible to extend one-direction UE's reception capacity.

As one option, the network can configure SMTC with STOW with respect to ephemeris data, UE position and feedback by UE. The network may have knowledge that no need to keep one side of SMTC duration as usual, and same length of duration in one side can be cut when STOW extend duration at the other side.

FIG. 5F is a diagram showing time shifted STOW. The aspect of STOW, as demonstrated in FIG. 5F, is that STOW is not always used to extend duration of SMTC. Time shifted STOW is also feasible to shift SMTC and keep original length of duration of SMTC unchanged.

FIG. 5G is a diagram showing a solution with STOW concept to problem in FIG. 5C. Therefore, problem in FIG. 5C can be solved by STOW concept, as shown in FIG. 5G. Once UE2 and UE3 are patched by time shifted STOW, it implies that UE2 and UE3 can use time in STOW to do more measurements about actual SSB. There will be no missed part during measurement.

FIG. 5H is a diagram showing exemplary parameters in the STOW configuration. Another aspect of STOW is the range/duration/length of STOW can be one or more than one symbols. In one example, one parameter may include a predefined list of range/duration/length of STOW {r1, r2, r3 . . . }, as shown in FIG. 5H. Also, choice in {r1, r2, r3 . . . } may be time changing with respect to another parameter, which includes a predefined list of time duration {tr1, tr2, tr3 . . . }. For example, r1 is valid in a predefined time duration tr1, r2 is valid in a predefined time duration tr2 and so on. In an example, the total time of tr1+tr2+tr3 . . . may be less than SMTC periodicity.

From another standpoint, r1, r2, r3 . . . indicate allowed shift level of SMTC. From another standpoint, r1, r2, r3 . . . and corresponding valid time tr1, tr2, tr3 . . . indicate allowed shift rate of SMTC. In one example, other parameters s1=r1/tr1, s2=r2/tr2, s3=r3/tr3 directly indicate the shift rate of SMTC. For example, {r1, r2, r3 . . . }, {tr1, tr2, tr3 . . . }, {s1, s2, s3 . . . } can be predefined, configured by network or decided by UE.

One example is that a range of STOW shall have relationship to duration of SMTC {td1, td2, td3, . . . }, e.g., if duration of SMTC is Td1, the allowed STOW shall be r1. If duration of SMTC is Td2, the allowed STOW shall be r2.

Another example relevant to range of STOW is that the network may indicate UE a reference STOW instead of rules to set STOW's duration as above, in terms of knowledge of the UE's location and the ephemeris data and feeder link delay of the satellite serving the cell(s) the configuration targets (e.g., cell(s) associated with the configuration). If the network, at the time when the configuration is to be created, does not have fresh or accurate enough information about the UE's location, the network may request the UE to signal the UE's location to the network.

As one option, duration of STOW associated with a SMTC configuration with a group of cells could be optionally associated to the configuration of cell/SSB-IDs and/or Satellite IDs. The examples are as follows. If cell/SSB-IDs and/or Satellite IDs belong to a set1(ID1, ID2 . . . ), the allowed STOW parameters shall be {r1, tr1, s1}. If cell/SSB-IDs and/or Satellite IDs belong to set2(ID1, ID2 . . . ), the allowed STOW shall be {r2, tr2, s2}, etc.

The extended range of STOW durations allows the network, e.g., the gNB, to configure some extra margin in the window. Therefore, the time of reception of the SSB transmissions, due to satellite movements, can “slide” within the STOW for a while before range of STOW has to be updated/shifted/switched. If {r1, r2} of STOW cannot cover propagation delay changes, SMTC duration may be changed from Td1 to Td2 and so on, meanwhile STOW shall be updated according to above embodiments.

Another possibility of the embodiment is that STOW may face specific situation in case of multi-SMTCs. STOW instances may be also applied in such case of multi-SMTCs.

FIG. 5I is a diagram showing exemplary multiple STOWs for multiple SMTC.

Taking FIG. 5I as an example, in case 1, STOW1 of SMTC1, STOW2 of SMTC2 have not been overlapping (possibly with partial collision or being close in time (e.g., within certain time margin), but do not overlap in time). In Case 2, STOW1 and STOW2 are overlapping but SMTC1 and SMTC2 are not overlapping (possibly with partial collision or being close in time (e.g., within certain time margin), but do not overlap in time). In Case 3, SMTC1, SMTC2 are overlapping.

If UE cannot measure the overlapping SMTCs simultaneously, network or UE determines which one of the two overlapping SMTC+STOW to be kept, and which one of the two overlapping SMTCs to be cancelled.

There are some solutions which can deal with the issue, e.g., in one occasion, STOW1 is used for SMTC1, and SMTC2 without STOW2 is measured. In next occasion, STOW2 is used for SMTC2 and SMT1 without STOW1 is measured. Alternatively, one of STOW, e.g., STOW1 used for SMTC1, may be always prioritized, and SMTC2 is measured without STOW2. The specific priority may be based on different characteristics or configurations of SMTC1 and SMTC2. Further, shorter STOW1 and/or STOW2 may be configured to avoid collision.

Distinguishment between a scenario1 with disabled STOW and a scenario2 with enabled STOW may be related to following parameters, e.g., validity or invalidity of ephemeris data; validity or invalidity UE position; satellite types; location of some neighbor satellites; time to cover area by some neighbor satellites; UE's capacity; SMTC configurations.

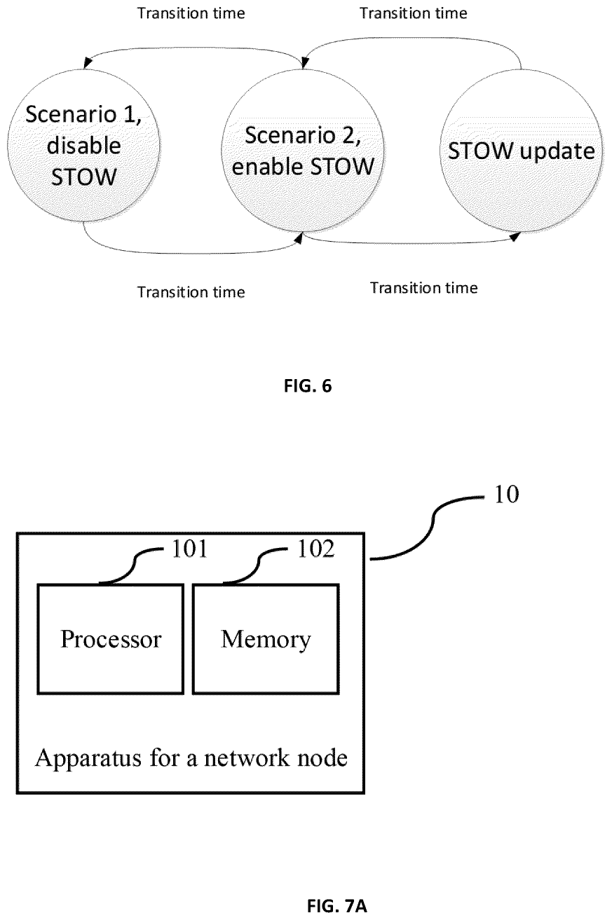

FIG. 6 is a diagram showing switching between different scenarios. As shown in FIG. 6, switching between scenario1 with disabled STOW and scenario2 with enabled STOW can be signaled by network, by explicit signaling. Alternatively the switching can be triggered implicitly/automatically based on change or update of above parameters. Allowing that network and UE shall be in sync on STOW validity and configuration, explicit signaling by network is preferred. Also, UE's assistance may support network to configure appropriate STOW to UE.

In one example, network configures one of SMTCs for a GEO and a LEO with STOW. After coverage of LEO expires, network may update the SMTC without STOW to only reserve for the GEO.

In another example, when UE cannot identify SSB or detect low signal strength/quality SSB in SMTC without STOW, UE may request STOW to network.

In another example, when valid time for SMTC without STOW expires, UE may request STOW to network.

In another example, when UE has invalid Global Navigation Satellite System (GNSS) position information, UE may request STOW to network.

In another example, if network only configures one SMTC, network may enable STOW in order to secure high robustness of the only SMTC.

Alternatively, switching between scenario1 with disabled STOW and scenario2 with enabled STOW can be performed by UE based on change or update of above parameters. Allowing that network and UE shall be in sync on STOW validity and configuration, UE informs NW with enabling or disabling STOW and/or detailed STOW parameters, e.g., r1, r2, r3. Also, NW may provide UE assistance information to facilitate UE to configure appropriate STOW.

In one example, network configures one of SMTCs for a GEO and a LEO with STOW. After coverage of LEO expires, UE may only perform the SMTC without STOW to only reserve for the GEO.

In another example, when UE cannot identify SSB or detect low signal strength/quality SSB in SMTC without STOW, UE may perform STOW and notice network enabling or disabling STOW and/or detailed STOW parameters, e.g., r1, r2, r3.

In another example, if valid time for SMTC without STOW expires, UE may perform STOW.

In another example, if UE has invalid GNSS position information, UE may perform STOW.

In another example, if network only configures one SMTC, UE may enable STOW in order to secure high robustness of the only SMTC.

As shown in FIG. 6, switching between scenario1 with disabled STOW and scenario2 with enabled STOW needs transition time, and also update of parameters for STOW, e.g. {r1, r2, r3 . . . } with {tr1, tr2, tr3 . . . } or {s1, s2, s3 . . . }. When STOW is merely updated, transition time is also needed.

When the UE transitions between any two scenarios when enabling the STOW, changing STOW configuration, disabling the STOW, the UE shall drop the measurements for the first (previous) scenario and not expected to meet any measurement requirement. After the transition time interval, the UE has to restart the measurement and meet the requirement corresponding to the second (new) state.

Yet another aspect of the embodiment is a set of measurement procedures and requirements, including P2 applied to the UE when STOW is enabled; and P1 applied to the UE when STOW is disabled. P1 or P2 may be for L1-RSRP and/or SS-RSRP. Furthermore, depends on duration of STOW {r1, r2}, there can be two different measurement procedures and requirements, e.g., P2-1 and P2-2.

Examples of requirements on measurement procedures and requirements are measurement time, measurement accuracy, number of identified cells to be measured per carrier, number of beams (e.g., SSBs) to be measured, etc. Examples of measurement time are cell detection time, measurement period of a measurement (e.g. synchronisation signal reference signal received power, SS-RSRP, SS reference signal received quality, SS-RSRQ, SS signal interference to noise ratio SS-SINR etc.), SSB index acquisition time, measurement reporting delay, radio link monitoring (RLM) evaluation period (e.g. out of sync evaluation period, in sync evaluation period, beam detection evaluation period, candidate beam detection evaluation period, measurement period of L1-measurement (e.g. L1-RSRP, L1-SINR etc.), SMTC number in one MO (measurement object)/frequency layer, number of carriers/frequencies/cells to be measured and etc.

As an example, P2 requirements may be more stringent than P1 requirements. Further, in P2, there may be P2-1 (corresponding to a parameter r1), P2-2 (corresponding to a parameter r2), and P2-3. P2-2 requirements may be more stringent than P2-1 requirements when r2>r1. The term ‘stringent’ is interchangeably called as stricter, less relaxed, tighter, more demanding, more difficult, etc.

TABLE 2
Requirements on measurements

| | STOW is | STOW is | STOW is | |
|---|---|---|---|---|
| | enabled with | enabled with | enabled with | STOW is |
| | {r1, tr1, s1} | {r2, tr2, s2} | {r3, tr3, s3} | disabled |
| Measurement | P2-1 | P2-2 | P2-3 | P1 |
| procedure and | | | | |
| requirements | | | | |

To meet or fulfil more stringent requirements, the UE needs to allocate or assign more resources for performing and processing the measurements compared to the case when the UE has to meet less stringent requirements. Examples of resources are processor units, memory units, battery power etc. Examples of requirements are measurement time, measurement rate, measurement accuracy of the measurement for SS-RSRQ, SS-RSRP, etc., number of cells to measure over a measurement time, number of carriers to monitor, signal level for SINR, SS-RSRP, etc., other limitations the requirements need to meet, etc. Examples of measurement time are measurement period or L1 measurement period, evaluation period, cell detection time etc. In one example, a shorter measurement time is more stringent (or less relaxed) than the longer measurement time of the same type of measurement (e.g., measurement for SS-RSRP). In another example a shorter cell detection time is more stringent than the longer cell detection time for the same type of cell, e.g., NR inter-frequency cell.

The difference between the P1 and P2 are described with several examples below.

In P2, UE measures on a greater number of beams (e.g., SSBs) compared to those in P1, or in a contrary manner or direction.

In P2, UE performs faster measurements on one or more neighbor cells (or carriers, frequencies) than in P1. In one example, UE measures fewer neighbor cells than in P1, in a contrary manner or direction.

In P2, the UE is allowed to perform measurements according to one or more of the following mode of operations: UE perform measurements while meeting shorter or longer requirements, e.g., shorter or longer measurement time (Tms) than a reference measurement time (Tmr), e.g., when Tms<Tmr or Tms>Tmr. In one example K*Tms=Tmr; where K>1. In another example Tms=400 ms while Tmr=1600 ms for the same measurement, e.g., for SS-RSRP.

Further, when STOW is utilized in RRC_CONNECTED state, an aspect is about scheduling restriction with STOW. The scheduling restriction shall be applied to SSB symbols under some conditions. For example, the UE is not expected to transmit PUCCH/PUSCH/SRS or receive PDSCH/PDCCH/TRS/CSI-RS for CQI on SSB symbols to be measured, or on number of symbols before and after each consecutive SSB symbols to be measured which may be in SMTC or in STOW, or on all symbols within SMTC+STOW window duration.

Referring back to FIG. 5I, in case 1, when STOW1 of SMTC1, STOW2 of SMTC2 are not overlapping. Scheduling restriction shall be applied to each SMTC and STOW.

In case 2, when STOW1 and STOW2 are overlapping but SMTC1 and SMTC2 are not overlapping, scheduling restriction shall be applied to each SMTC and the union of STOWs between STOW1 and STOW2.

In case 3, when SMTC1, SMTC2 are overlapping. Scheduling restriction shall be applied to the union of SMTCs and the STOW1 before SMTC1 and STOW2 after SMTC2.

When STOW is utilized in RRC_IDLE/INACTIVATED state, an aspect is that paging occasion shall not be occupied by STOW.

An example is that STOW shall be limited, so as to avoid being too close to or colliding with paging occasion.

Another example is that, a SMTC with the STOW too close to or colliding with paging occasion shall be dropped to ensure paging activities and longer measurements delay are expected.

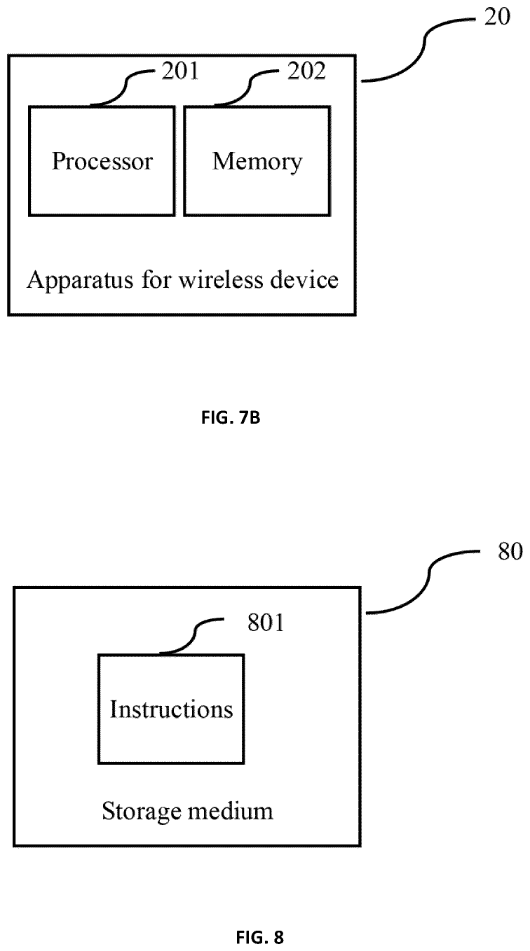

FIG. 7A is a block diagram showing an exemplary apparatus for a network node, which is suitable for perform the method according to embodiments of the disclosure.

As shown in FIG. 7A, an apparatus 10 for a network node in a communication network may comprise: a processor 101; and a memory 102. The memory contains instructions executable by the processor. The apparatus 10 for the network node is operative for: determining a first configuration for a SSB measurement time; wherein SSB refers to a combination of synchronization signal and physical broadcast channel; determining a second configuration for indicating an offset related to the SSB measurement time; and transmitting the first configuration and the second configuration to a wireless device, for indicating that the wireless device performs a SSB measurement, based at least on the first configuration and/or the second configuration.

In embodiments of the present disclosure, the apparatus 10 is further operative to perform the method according to any of the above embodiments, such as these shown in FIG. 2, 4.

FIG. 7B is a block diagram showing an exemplary apparatus for a wireless device, which is suitable for perform the method according to embodiments of the disclosure.

As shown in FIG. 7B, an apparatus 20 for a wireless device may comprise: a processor 201; and a memory 202. The memory contains instructions executable by the processor. The apparatus 20 for the wireless device is operative for: receiving, a first configuration and a second configuration from a network node in a communication network; and performing a SSB measurement, based at least on the first configuration and/or the second configuration. The first configuration is for a SSB measurement time, and the second configuration is for indicating an offset related to the SSB measurement time.

In embodiments of the present disclosure, the apparatus 20 may be further operative to perform the method according to any of above embodiments, such as these shown in FIG. 3, 4.

The processors 101, 201 may be any kind of processing component, such as one or more microprocessor or microcontrollers, as well as other digital hardware, which may include digital signal processors (DSPs), special-purpose digital logic, and the like. The memories 102, 202 may be any kind of storage component, such as read-only memory (ROM), random-access memory, cache memory, flash memory devices, optical storage devices, etc.

FIG. 8 is a block diagram showing an apparatus/computer readable storage medium, according to embodiments of the present disclosure.

As shown in FIG. 8, the computer-readable storage medium 80, or any other kind of product, stores instructions 801, which when executed by at least one processor, cause the at least one processor to perform the method according to any one of the above embodiments, such as these shown in FIG. 2, 3, 4.

In addition, the present disclosure may also provide a carrier containing the computer program/instructions as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

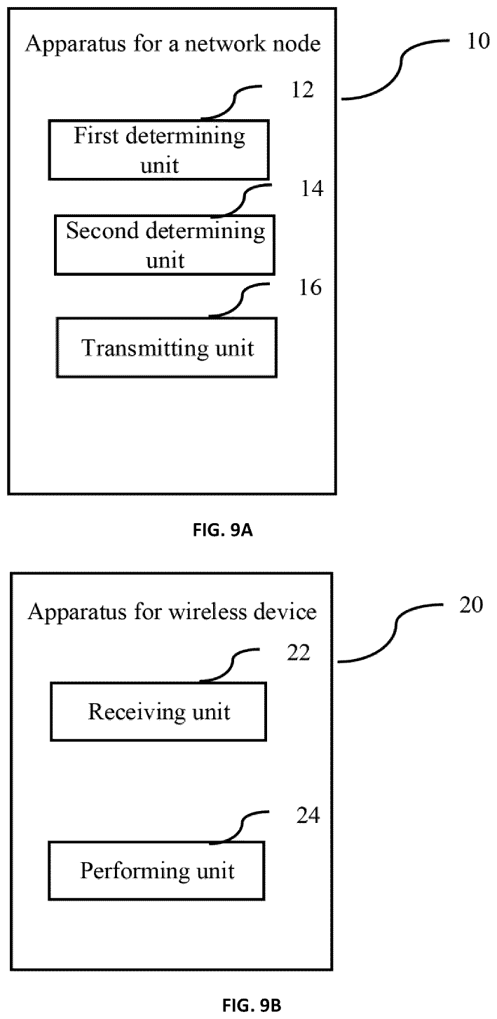

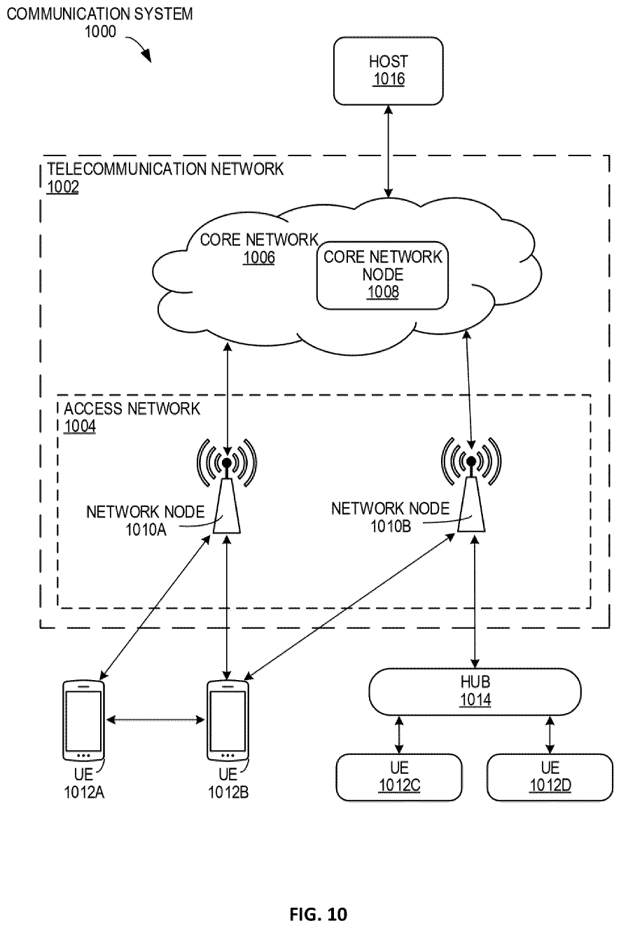

FIG. 9A is a schematic showing units for the exemplary apparatus for a network node, according to embodiments of the present disclosure.

As shown in FIG. 9A, the apparatus 10 for a network node may comprise: a first determining unit 12, configured to determine a first configuration for a SSB measurement time; wherein SSB refers to a combination of synchronization signal and physical broadcast channel; a second determining unit 14, configured to determine a second configuration for indicating an offset related to the SSB measurement time; and a transmitting unit 16, configured to transmit the first configuration and the second configuration to a wireless device, for indicating that the wireless device performs a SSB measurement, based at least on the first configuration and/or the second configuration.

In embodiments of the present disclosure, the apparatus 10 is further operative to perform the method according to any of the above embodiments, such as these shown in FIG. 2, 4.

FIG. 9B is a block diagram showing an exemplary apparatus for a second network node, which is suitable for perform the method according to embodiments of the disclosure.

As shown in FIG. 9B, an apparatus 20 for a second network node in a second communication network may comprise: a receiving unit 22, configured to receive a first configuration and a second configuration from a network node in a communication network; and a performing unit 24, configured to perform a SSB measurement, based at least on the first configuration and/or the second configuration. The first configuration is for a SSB measurement time, and the second configuration is for indicating an offset related to the SSB measurement time.

In embodiments of the present disclosure, the apparatus 20 may be further operative to perform the method according to any of above embodiments, such as these shown in FIG. 3, 4.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With these units, the apparatus may not need a fixed processor or memory, any computing resource and storage resource may be arranged from at least one network node/device/entity/apparatus relating to the communication system. The virtualization technology and network computing technology (e.g. cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Particularly, these function units may be implemented either as a network element on a dedicated hardware, as a software instance running on a dedicated hardware, or as a virtualized function instantiated on an appropriate platform, e.g., on a cloud infrastructure.

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

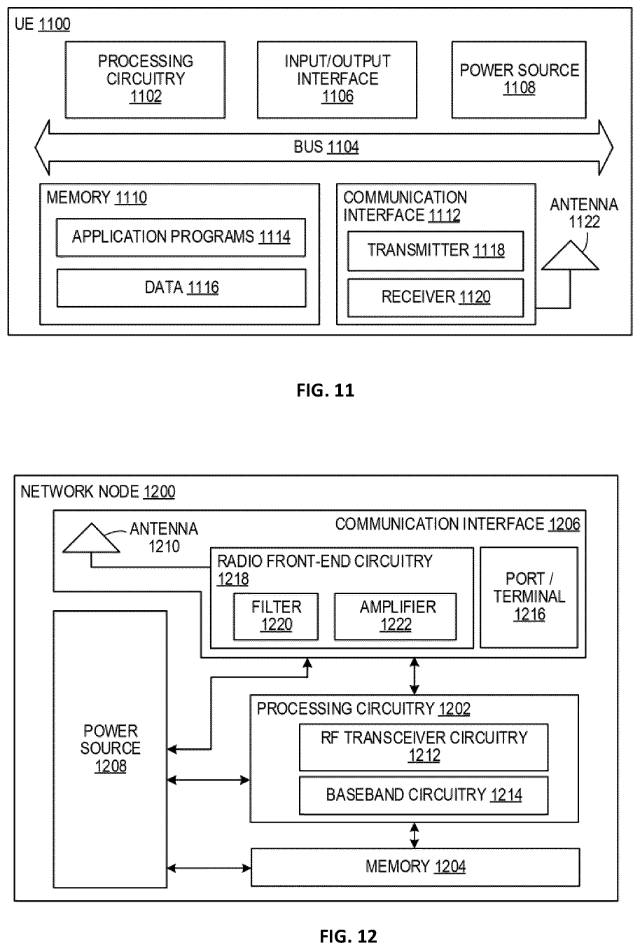

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

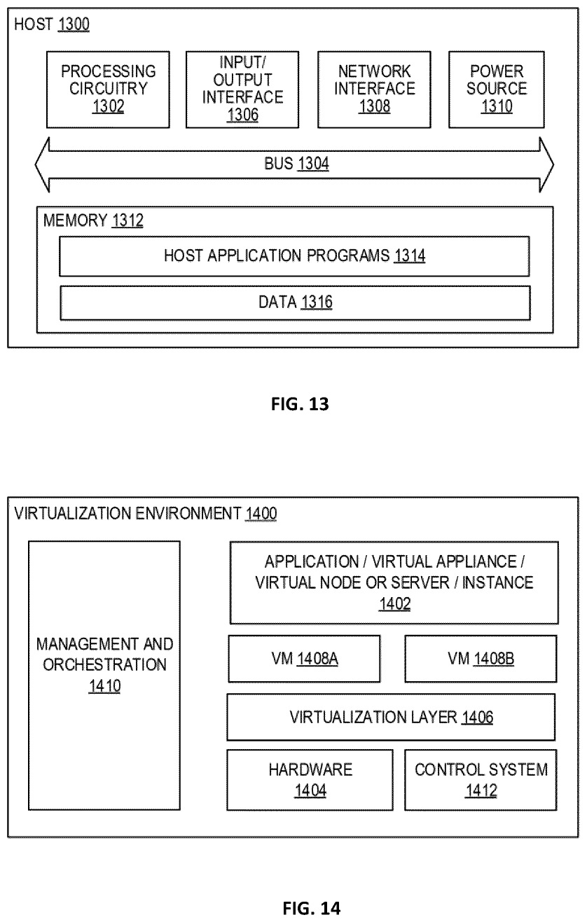

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

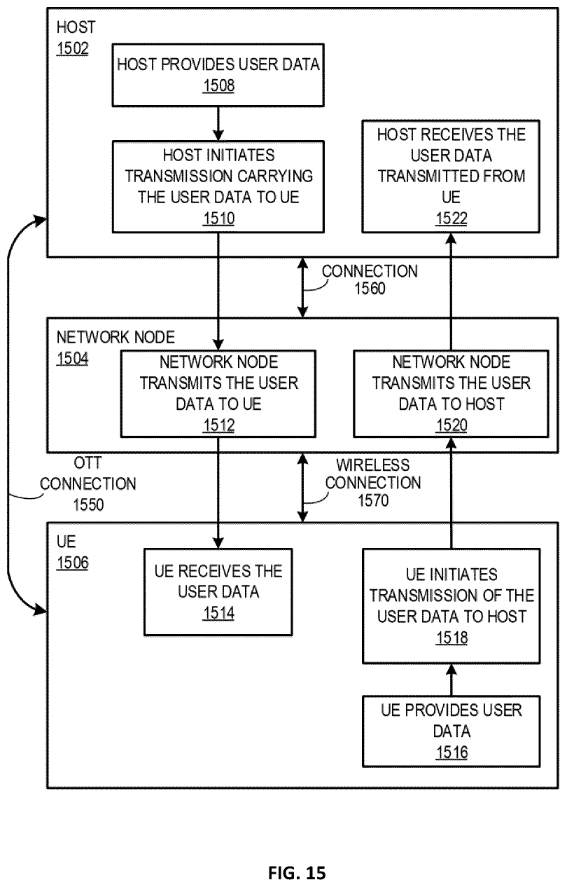

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. According to embodiments of the present disclosure, an offset related to the SSB measurement time may be indicated. The specific SSB measurement may be adjusted accordingly. Therefore, the influence of a moving base station/relay, such as a moving satellite, for the time align of SSB may be reduced. The measurement quality for the SSB in such situations may be enhanced. More precisely, the teachings of these embodiments may improve the performance, e.g., data rate, latency, power consumption, of the communication network, and thereby provide benefits such as reduced user waiting time, relaxed restriction on file size, improved content resolution, better responsiveness, extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OT connection 1550 between the host 1502 and UE 1506, in response to variations in the measurement results. The measurement procedure and/or the network functionality for reconfiguring the OT connection may be implemented in software and hardware of the host 1502 and/or UE 1506. In some embodiments, sensors (not shown) may be deployed in or in association with other devices through which the OT connection 1550 passes; the sensors may participate in the measurement procedure by supplying values of the monitored quantities exemplified above, or supplying values of other physical quantities from which software may compute or estimate the monitored quantities. The reconfiguring of the OT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Any of the embodiments of the present disclosure may be utilized as supplements to 3GPP TS, such as to 3GPP TS 38.133, Rel. 17 (e.g., V17.4.0).

1.-49. (canceled)

50. A method performed by a network node in a communication network, comprising:
determining a first configuration for a synchronization signal block (SSB) measurement time, wherein SSB refers to a combination of synchronization signal and physical broadcast channel;
determining a second configuration for indicating an additional timing offset window to be applied to the SSB measurement time; and
transmitting the first configuration and the second configuration to a wireless device, for indicating that the wireless device performs a SSB measurement, based at least on the first configuration and the second configuration.

51. The method according to claim 50,
wherein the first configuration comprises: a periodicity, and a duration of the SSB measurement time; and
wherein the second configuration comprises: a timing offset window related to the duration of the SSB measurement time.

52. The method according to claim 51,
wherein the duration of the SSB measurement time is extended by the timing offset window, to start earlier compared to the first configuration; and/or
wherein the duration of the SSB measurement time is extended by the timing offset window, to end later compared to the first configuration.

53. The method according to claim 51,
wherein the duration of the SSB measurement time is shifted by the timing offset window, to start earlier compared to the first configuration; or
wherein the duration of the SSB measurement time is shifted by the timing offset window, to end later compared to the first configuration.

54. The method according to claim 51,
wherein the timing offset window is constant; or
wherein the timing offset window is periodically changeable with an update rate.

55. The method according to claim 50,
wherein the second configuration is enabled or disabled, based at least on an indication from the network node, and/or a report from the wireless device, and/or a predefined rule.

56. The method according to claim 50,
wherein the first configuration and the second configuration are provided from a satellite to the wireless device; and
wherein the second configuration is determined, based at least on a location of the wireless device, an ephemeris data and/or feeder link delay of the satellite.

57. The method according to claim 56,
wherein the second configuration is enabled or disabled for the wireless device, based on a change of at least one of following:
a validity or invalidity of the ephemeris data,
a validity or invalidity of the location of the wireless device,
a type of the satellite,
a location of at least one neighbor satellite, or
a time to be covered by at least one neighbor satellite; or
wherein the second configuration is enabled or disabled for the wireless device, based on at least one of the following:
a capacity of the wireless device; or
the first configuration.

58. The method according to claim 50, wherein a duration of the SSB measurement time and/or the second configuration is disabled, when the duration is close to or collides with a paging occasion.

59. The method according to claim 50,
wherein the network node comprises a satellite or a base station relayed by the satellite.

60. A method performed by a wireless device, comprising:
receiving a first configuration and a second configuration from a network node in a communication network, wherein the first configuration is for a synchronization signal block (SSB) measurement time, and the second configuration is for indicating an additional timing offset window to be applied to the SSB measurement time; and
performing an SSB measurement based at least on the first configuration and the second configuration.

61. The method according to claim 60,
wherein the first configuration comprises: a periodicity, and a duration of the SSB measurement time; and
wherein the second configuration comprises: a timing offset window related to the duration of the SSB measurement time.

62. The method according to claim 61,
wherein the duration of the SSB measurement time is extended by the timing offset window, to start earlier compared to the first configuration; and/or
wherein the duration of the SSB measurement time is extended by the timing offset window, to end later compared to the first configuration.

63. The method according to claim 61,
wherein the duration of the SSB measurement time is shifted by the timing offset window, to start earlier compared to the first configuration; or
wherein the duration of the SSB measurement time is shifted by the timing offset window, to end later compared to the first configuration.

64. The method according to claim 61,
wherein the timing offset window is constant; or
wherein the timing offset window is periodically changeable with an update rate.

65. The method according to claim 60,
wherein the second configuration is enabled or disabled, based at least on an indication from the network node, and/or a report from the wireless device, and/or a predefined rule.

66. A network node in a communication network, the network node comprising:
a processor; and
a memory, the memory containing instructions executable by the processor, whereby the apparatus for the network node is configured to:
determine a first configuration for a synchronization signal block (SSB) measurement time; wherein SSB refers to a combination of synchronization signal and physical broadcast channel;
determine a second configuration for indicating an additional timing offset window to be applied to the SSB measurement time; and
transmit the first configuration and the second configuration to a wireless device, for indicating that the wireless device performs a SSB measurement, based at least on the first configuration and the second configuration.

67. A wireless device comprising:
a processor; and
a memory, the memory containing instructions executable by the processor, whereby the apparatus for the wireless device is configured to:
receive a first configuration and a second configuration from a network node in a communication network; wherein the first configuration is for a synchronization signal block (SSB) measurement time, and the second configuration is for indicating an additional timing offset window to be applied to the SSB measurement time; and
perform a SSB measurement, based at least on the first configuration and the second configuration.

68. The wireless device according to claim 67:
wherein the first configuration comprises: a periodicity, and a duration of the SSB measurement time; and
wherein the second configuration comprises: a timing offset window related to the duration of the SSB measurement time.

69. The wireless device according to claim 68:
wherein the duration of the SSB measurement time is extended by the timing offset window, to start earlier compared to the first configuration; and/or
wherein the duration of the SSB measurement time is extended by the timing offset window, to end later compared to the first configuration.
